(19) United States
(12) Patent Application Publication
(10) Pub. No.: US 2019/0034980 A1
(43) Pub. Date: Jan. 31, 2019

(54) VOUCHER SYSTEM

(71) Applicant: SONY INTERACTIVE ENTERTAINMENT INC., Tokyo (JP)

(72) Inventors: Sean Ian Allen, Campbell, CA (US); Matthew Bennett, Draper, UT (US); Alexandra Nsonwu, San Jose, CA (US)

(21) Appl. No.: 15/660,113

(22) Filed: Jul. 26, 2017

(51) Int. Cl. G06Q 30/02

(52) U.S. Cl. CPC G06Q 30/0277; G06Q 30/0267; H04L 67/12; G06Q 30/0273; G06Q 30/0255

(57) ABSTRACT

A scalable voucher system used to manage how content (specifically advertisements) is delivered to client devices is described. The advertisements are stored on a plurality of different ad servers. With the use of vouchers that are assigned to each ad server for pre-determined periods of time, the voucher system is able to manage when and how advertisements should be provided to the client devices. The voucher system also provides an arrangement that allows for the use of additional ad servers to be scalable. As the number of client devices that would need to be serviced with advertisements increases, the voucher system is able to easily accommodate the increase number of clients with the implementation of additional clusters of ad servers and corresponding processors without significant changes to the underlying system.

### BACKGROUND

### Field of Invention

The present invention generally relates to advertisement management. More specifically, the present invention relates to the use of a voucher system that manages advertisements within a network.

### Description of the Related Art

There exist services that promote a party's advertisements that include pay-per-click, pay-per-impression, and display ads. For example, an advertiser may wish to promote a product or service. Therefore, the advertiser may choose to work with an advertising service and pay for a set number of impressions over a period of time.

However, problems may occur for both the advertisement service provider and the advertiser. First, as more advertisers seek out the services, there may be a limit to how many advertisements can be supported using established servers associated with the service provider. Furthermore, based on the client base, the available servers for the service may not be capable of servicing all the clients.

On the advertiser side, the advertiser would like to ensure that the paid number of advertisements (e.g. via impressions) is provided evenly over the period of time. This provides more possible views over the duration of the advertisement campaign. Many times, advertisements may be merely front-loaded so that all the impressions are performed near the beginning of the advertisement campaign as the service provider provides the advertisements at every possible situation. However, near the end of the advertisement campaign, the paid impressions would have been all used up.

There is a need for a scalable process that could allow for increase capabilities to support more advertisement campaigns and service more clients. There is also a need for management of the advertisement campaigns.

### SUMMARY OF THE CLAIMED INVENTION

A method for managing advertisements is presently claimed. The method includes ad servers that include advertisements. Each of the ad servers may request permission to transmit advertisements to client devices. Upon receiving the request, a processor identifies advertisement campaign details associated with the request. Vouchers are subsequently generated for each ad server that includes a point value and expiration time corresponding to the advertisement campaign details. These vouchers are transmitted to the ad servers that then dictate how advertisements are provided to client devices. The ad servers provide information about the advertisement transactions to the processor so that new vouchers can be generated.

A system for managing advertisements is also presently claimed. The system includes a campaign server that includes campaign details that controls how advertisements will be transmitted to client devices during the advertisement campaign. The system also includes a plurality of client devices that will receive the advertisements from the system. Lastly, the system includes advertisement clusters that include ad servers and processors. Each of the ad servers includes advertisements. Each of the ad servers may request permission to transmit advertisements to client devices. Upon receiving the request, a processor identifies advertisement campaign details associated with the request. Vouchers are subsequently generated for each ad server that includes a point value and expiration time corresponding to the advertisement campaign details. These vouchers are transmitted to the ad servers that then dictate how advertisements are provided to client devices. The ad servers provide information about the advertisement transactions to the processor so that new vouchers can be generated.

A computer readable non-transitory storage medium is also presently claimed. The storage medium has a program that is executed to perform a method for managing advertisements is presently claimed. The method includes ad servers that include advertisements. Each of the ad servers may request permission to transmit advertisements to client devices. Upon receiving the request, a processor identifies advertisement campaign details associated with the request. Vouchers are subsequently generated for each ad server that includes a point value and expiration time corresponding to the advertisement campaign details. These vouchers are transmitted to the ad servers that then dictate how advertisements are provided to client devices. The ad servers provide information about the advertisement transactions to the processor so that new vouchers can be generated.

### BRIEF DESCRIPTION OF THE DRAWINGS

FIG. 1 illustrates a voucher system.

FIG. 2 illustrate a method for managing advertisements using the voucher system of FIG. 1.

FIG. 3 illustrates the voucher system of FIG. 1 within an overall points system.

FIG. 4 illustrates a block diagram of an example user (i.e. client) device.

### DETAILED DESCRIPTION

The present disclosure describes a scalable voucher system that is used to manage how content (specifically advertisements) are delivered to client devices. The advertisements are stored on a plurality of different ad servers. With the use of vouchers that are assigned to each ad server for pre-determined periods of time, the voucher system is able to manage when and how advertisements should be provided to the client devices. The voucher system also provides an arrangement that allows for the use of additional ad servers to be scalable. As the number of client devices that would need to be serviced with advertisements increases, the voucher system is able to easily accommodate the increase number of clients with the implementation of additional clusters of ad servers and corresponding processors without significant changes to the underlying system.

As used herein, the term voucher refers to an electronic voucher assigned to each ad server that includes a value (e.g. points) and an expiration. The voucher is used to dictate how many times an advertisement can be shown by the ad server within a particular period of time set by the expiration. Each transmission of an advertisement provided by the ad server to a client device can decrement the value of the voucher. Once the voucher value has been depleted or the expiration occurs, the ad server may no longer be allowed to transmit advertisements to client devices until a new voucher is issued to that client device.

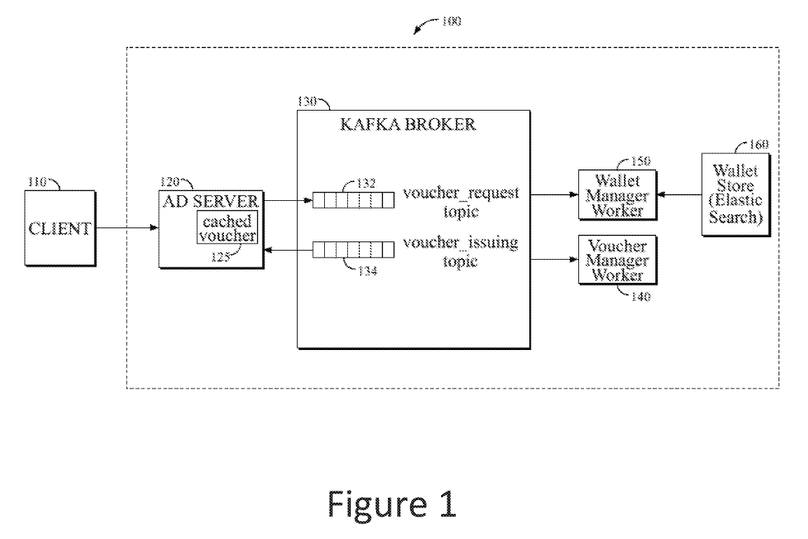

FIG. 1 illustrates a voucher system 100. The voucher system 100 facilitates how advertisements stored within one or more ad servers 120 are provided to the client devices 110. In particular each of the ad servers 120 are provided a voucher that indicates how many times a particular advertisement would be shown to client devices 110 within a pre-determined period of time. Furthermore, instructions may also be provided to the ad servers 120 that dictate which client device 110 should be provided the advertisements.

The voucher system 100, in addition to the ad servers 120 mentioned above, also includes a processor (e.g. Kafka Broker) 130, voucher manager worker 140, wallet manager worker 150, and a wallet store 160. Additional details regarding each of the elements of FIG. 1 will be provided below.

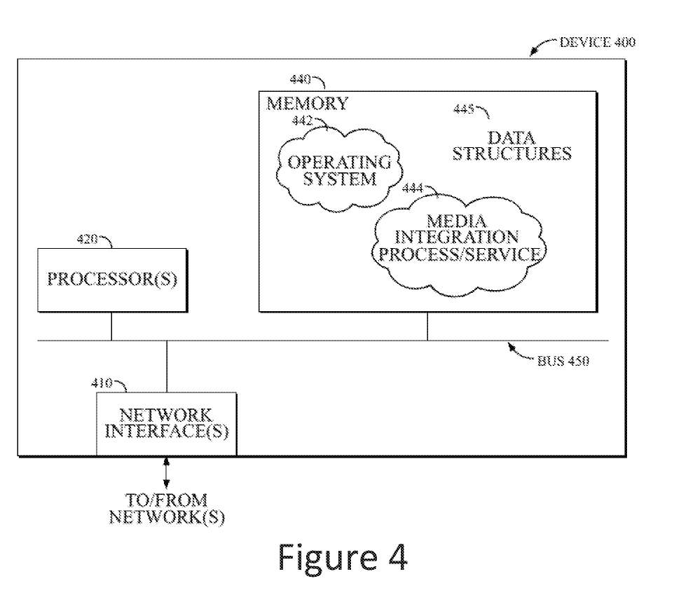

The client device 110 can be any number of different computing devices. For example, the client device 110 may include mobile devices, laptops, desktops, and gaming consoles. Further details regarding the client device 110 will be provided below in FIG. 4.

Although FIG. 1 only includes one client device 100, it should be noted that the voucher system 100 may include a plurality of client devices 110 that would need to each be serviced with any number of different advertisements via the voucher system 100. A user associated with the client device 110 can view these advertisements on a display associated with the client device 110. Furthermore, the advertisements that are displayed on the client device 110 may be specifically chosen from the ad servers 120 for the user for viewing based on known information about the user. The client device 110 would be capable of transmitting user information (e.g. preferences, viewing history, purchase history) that can be used to identify advertisements that the user would be interested in viewing. This user information may be voluntarily provided by the user via surveys or the like. User information can also be extracted about the user using information stored on the client device 110, for example, based on a record of history of user activity on the client device 110.

In a first situation, if the user has previously viewed a particular content on the client device 110, advertisements may be provided to the user related to the previously viewed content. Content that is considered “related” may be pre-determined, for example, based on an associated genre. In another situation, if the client device 110 is a console and the user has purchased and/or played a particular game, the user may receive advertisements for other games that may be considered “related” to the purchased and/or played game where such “related” games may be within the same genre, be from the same game studio/producer, or may share some number of characteristics (e.g. art-style, story-driven, rating). Users can also be provided content based on user profiled information that can be used to identify “related content.”

When the client device 110 connects with the voucher system 100, the client device 110 may request the voucher system 100 for an advertisement. In an example situation, the user may access an application on the client device 110 that may be instructed to show advertisements to the user at regular intervals. So when the user accesses the application on the client device 110, a request for an advertisement may be sent to the voucher system 100 so that an appropriate advertisement is provided.

When the same client device 110 connects to the voucher system 100 over a period of time, different ad servers 120 may be connected with the client device 110. Described in detail below, each ad server 120 may be assigned to a request from the client device 110 randomly. In other situations, an ad server 120 that has the most available bandwidth (or least work load) may be assigned to the requesting client device 110. Other considerations such as relevant advertisements stored on the ad server 120 compared to the user's interest associated with the client device 110 can also be used to determine which ad server 120 should be connected to the client device 110.

As illustrated in the figure, the ad server 120 is associated with the voucher system 100. The ad server 120 may include a plurality of different advertisements that can be provided to the client device 110. The advertisements may be associated with the same or different advertisement campaigns run on the voucher system 100. Based on an assigned voucher, the corresponding advertisement(s) can be provided to the client device 110 upon request.

Although the figure only illustrates one ad server, it should be noted that the voucher system 100 may include a plurality of ad servers 120. The number of ad servers 120 that are associated with the voucher system 100 may be based on managing capabilities of the processor 130 to oversee the plurality of ad servers 120.

The ad servers 120 of the voucher system 100 would each have a cached voucher 125. As described in further detail below, a voucher is issued to each ad server 120 that dictates how many times a particular advertisement (or group of advertisements) should be shown within a particular period of time. For example, a voucher can identify that an advertisement about a particular game should be shown to particular clients 100 times within a span of ten minutes. Whenever an advertisement associated with the voucher is provided to the client device 110, that value the voucher has (e.g. 100 views) can be decremented. In situations where batches of advertisements are provided to the client device 110, the value of the voucher can be decremented by a number that corresponds to the number of advertisements within the voucher. Once the value of the voucher stored in the cached voucher 125 has been depleted, the ad server 120 can stop providing advertisements associated with the voucher to client devices 110.

Furthermore, the ad server 120 may also be instructed to stop providing advertisements to client devices 110 once the period of time has elapsed. Time may be tracked by each of the ad servers 120. It may also be possible that the processor 130 provides time-based updates to the ad server 120 so that the ad server 120 would be informed when the period of time has elapsed.

The ad server 120 can also receive information from the client regarding user activity associated with the transmitted advertisement. In some cases, user views of the provided advertisement can be tracked as an impression. It may not be enough that ad servers 120 provide advertisements to the client device 110. Some advertisement campaigns may require that the voucher only be decremented based on impressions (or actual user views) of the advertisement. The ad server 120 can also receive information about other user activity (e.g. clicks, hovers) associated with the advertisements on the client devices 110. It should be noted that the information about each client device 110 may be associated with a unique identifier so that data from each client device 110 can be tracked and evaluated.

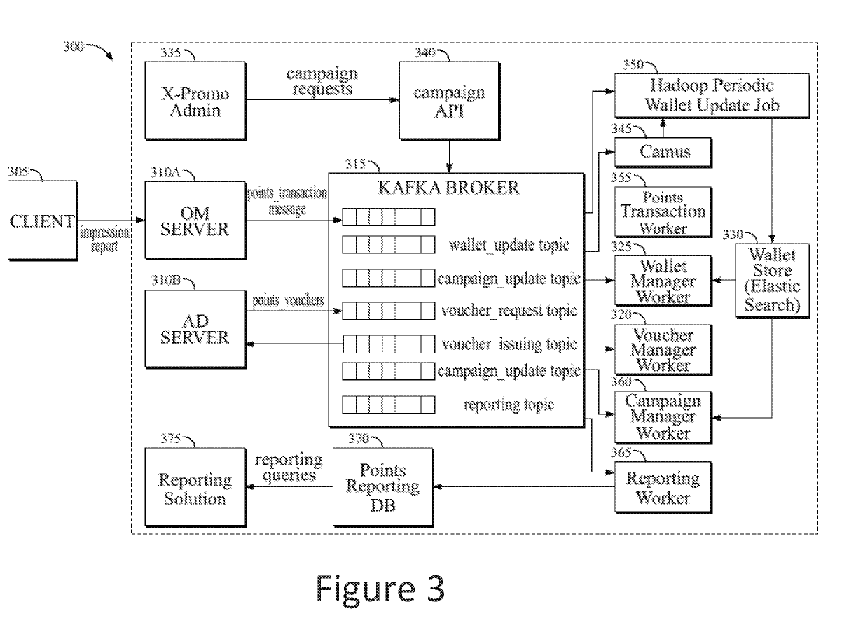

The processor 130 (e.g. kafka broker) facilitates communication between the ad server 120 and the voucher and wallet elements 140-160 of the voucher system 100. The processor 130 may include a plurality of different processes which facilitate the functionality of the voucher system 100. At least in FIG. 1, the processor 100 includes the processes of the voucher request topic 132 and the voucher issuing topic 134. As illustrated later in FIG. 3, the processor 130 may include various other processes in order to perform other functions.

As mentioned above, the processor 130 facilitates communication between different elements of the voucher system 100. Furthermore, the processor 130 would also be able to track the information being provided from the ad server 120. The tracked information can subsequently be stored or provided to other elements of the voucher system 100. For example, the processor 130 may include processes that facilitate in the tracking of how many request for advertisements are received by the ad server 120, how many advertisements have been shown by the ad server 120, how many advertisements have been viewed by users associated with the client devices 110, and user activity (e.g. clicks, hovers) associated with the advertisements on the client devices 110. The user activity information would be provided by the ad server 120.

In scenarios where the voucher system 100 includes a plurality of ad servers 120, the processor 130 can also be used to identify and select which ad server 120 should be used to communicate with a particular client device 110 in order to provide an advertisement. The identification can base the identification and selection on current loads of the ad servers 120. The processor 130 can aim to balance the loads (e.g. request for advertisements) received by the client devices 110 so that one ad server 120 within the voucher system 100 does not become overloaded with requests.

The processor 130 can also monitor the status of the ad server 120 so that in situations where one or more ad servers 120 become disabled for any reason (e.g. malfunction), the processor 130 can still carry out the features of the voucher system 100. In particular, the processor 130 would be able to audit what advertisements have been sent out by the ad server 120 prior to failure as well as find out the voucher that was assigned to that ad server 120. Additional information such as user activity associated with the advertisement from the client device 110 can also be used. By using the audited information obtained by the processor from the ad server 120 prior to failure, the processor 130 can calculate the remaining value left in the voucher so that it can be incorporated in the next voucher being assigned to the other operational ad servers 120 within the voucher system 100. Once the failed ad server 120 becomes operational again (e.g. after maintenance), the voucher system 100 may utilize the fixed ad server 120 when issuing the next set of vouchers.

The implementation of the voucher would be useful, for example, in managing a campaign for a product. In a situation where a party purchases an advertisement campaign for a product to be run during a weeklong period, the voucher would facilitate the breakdown of advertisement views so that the advertisements can be viewed throughout the week at regular interviews by the various client devices. For example, the voucher would allow a campaign where a party has paid for 1 million views of an advertisement over a week to spread those views throughout that time period (e.g. a set number of views daily, hourly, every 15 minutes). Without the use of the voucher, views for the advertisements may instead be frontloaded at the start of the campaign. In the example provided above, the 1 million views without the voucher may be fulfilled by the second or third day based on the level of activity involved between the client devices 110 and the ad servers 120.

The processor 130 provides a path for communication between the ad server 120 and the elements that track and issue the vouchers (e.g. voucher manager worker 140, wallet manager worker 150, wallet store 160). The processor 130 includes a plurality of different processes that are stored in memory (not shown) associated with the processor 130 that tracks all information going through the processor 130. The processor 130 may track data coming from the client devices 110 regarding what's happening with the advertisements. For example, the processor 130 may track how many requests for advertisements were provided from client devices 110, how many advertisements were shown by the ad server 120, the number of impressions for advertisements at the client devices 110, and any user activity at the client device 110 with the advertisements (e.g. clocks, hovers).

The processor 130 also includes processes ‘voucher request topic’ 132 and ‘voucher issuing topic’ 134. Voucher request topic 132 receives a request from the ad server 120 regarding providing advertisements to client devices 110. The processor 130 takes the request from the ad server 120 and then provides it to the voucher manager worker 140 and wallet manager worker 150. The request that is provided to the voucher manager worker 140 and the wallet manager work 150 may include information such as a unique identifier used to identify which ad server 120 is sending the request. When the advertisement request is sent from the processor 130 using the ‘voucher request topic’ 132 process to the voucher manager worker 140 and wallet manager workers 150 (described in further detail below), a voucher will subsequently be received that pertains to the specific ad server 120 that provided that request.

The processor 130 receives the voucher that will be sent to the ad server 120. The voucher may include additional information such as the unique identifier used to identify the appropriate ad server 120. The ‘voucher issuing topic’ 134 processes the information (e.g. unique identifier) in order to deliver the voucher to the appropriate ad server 120.

It should be noted that the processor 130 may include many other processes not illustrated in the figures. For example, there may be processes to monitor and poll for connectivity between the ad servers 120 and the processor 130. In situations where one or more ad servers 120 become unavailable or unresponsive, the processor 130 may also include processes that would facilitate the audit of information with respect to the ad server 120 prior to failure. In this way, the processor 130 may identify most if not all transactions for the failed ad server 120 with client devices prior to the failure and subsequently inform the voucher 140 and wallet manager workers 150 to redistribute any remaining values associated with the vouchers to the other ad servers 120 that are still operational in a next round of issued vouchers.

The voucher manager worker 140 of FIG. 1 manages the different advertisement campaigns that may be run on the voucher system 100. For example, the voucher manager worker 140 would have information about the number of points associated with each advertisement campaign as well as the time duration of the advertisement campaign. Each of this information would be obtained from the wallet store 160 (details provided below).

The voucher manager worker 140 would also include the details regarding how the points would be distributed to each of the ad servers 120 within the voucher system 100 during the time duration of the advertisement campaign. For example, the voucher manager worker 140 could include information that the ad servers associated with the voucher system 100 would each be assigned one hundred point vouchers (where each point corresponds to a transmission of an advertisement from the ad server 120 to a client device 110) with an expiration of fifteen minutes. With a total of three ad servers, the voucher system 100 would be issuing vouchers worth three hundred points every fifteen minutes. Each voucher would be used by each ad server 120 to monitor how many of the corresponding advertisement associated with the voucher would be provided to different client devices 110 over the next fifteen minutes. Once all one hundred points have been used, the ad server 120 may refrain from issuing further advertisements.

Based on the information stored in the voucher manager worker 140 regarding pending campaigns, when a request is provided from the processor 130 (via the voucher request topic process), the voucher manager worker 140 can evaluate how many points are remaining in the campaign and the time frame when the next set of vouchers should be issued. Vouchers can then be generated for each of the ad servers 120 for use in distributing advertisements for a next period of time.

In another embodiment, the voucher manager worker 140 can also utilize additional information about the previously issued vouchers from the ad servers 120. In particular, the voucher manager worker 140 can use this information to identify if some ad servers 120 receive more traffic (and thus spend all their points on their voucher) compared to other ad servers 120. Similarly, the voucher manager worker 140 can also identify if some ad servers 120 receive less traffic (and thus do not spend all their points on their voucher) compared to other ad servers 120.

In these situations, the voucher manager worker 140 can redistribute points on vouchers assigned to each ad server for the campaign during a time period so that different ad servers 120 have different numbers of points. So if ad server B is unable to spend all their points within specified time periods on a regular basis while ad server A spends all their points within the first half of the specified time period, it may be desired to redistribute some of the points for future vouchers assigned to server B to the voucher for server A. The overall points issued via vouchers within the specified time period, however, would not be altered. In the example above with three ad servers having three hundred points every fifteen minutes, ad server B may now be assigned sixty points while ad server A will now be assigned one hundred and forty points. The overall points provided for this specified time period, however, will still be three hundred (since an ad server C will still be assigned a voucher with one hundred points.

The wallet manager worker 150 communicates with the processor 130 in order to provide real-time updates about pending advertisement campaigns run on the voucher system 100. In particular, the wallet manager worker 150 can access and retrieve information from the wallet store 160 as needed regarding pending advertisement campaigns. In this way, the wallet manager worker 150 may provide the processor 130 with information such as the remaining number of point for or remaining duration for a particular advertisement campaign upon request. This information can be utilized by the processor 130 alongside the voucher manager worker 140 to issue a next voucher for the ad servers 120.

When the processor 130 receives information from the ad servers 120 regarding used vouchers and the points spent on each voucher, this information can be provided to the wallet manager work 150 so that the information associated with the corresponding advertisement campaign stored within the wallet store 160 can be updated accordingly. Such information may be provided to the processor 130 as soon as the voucher has been expended or after a time frame associated with the voucher has expired.

As noted above, in situations where one or more ad servers 120 experience failures, the processor 130 can audit information associated to vouchers issued and points used/remaining from the failed ad servers 120 up until the failure was detected. The audited information from the processor 130 can be provided to the wallet manager worker 150 to similarly update the wallet store 160 so that the advertisement campaign information can be kept up to date.

The wallet store 160 is a database associated with the advertisement campaigns run on the voucher system 100. As described above, the wallet store 160 includes details for each advertisement campaign run on the voucher system 100 and the associated advertisements stored on the ad servers 120. These details include, for example, the number of points (e.g. how many views each advertisement within the campaign will be provided) and the duration (i.e. time frame) of the campaign. Further details may also dictate how the points may be distributed across the different ad servers 120.

An application programming interface (not shown) may be implemented to allow users to upload new advertisement campaigns, modify existing advertisement campaigns, or remove expired advertisement campaigns from the wallet store 160. In some embodiments, expired advertisement campaigns may automatically be purged from the wallet store 160 after a pre-determined amount of time.

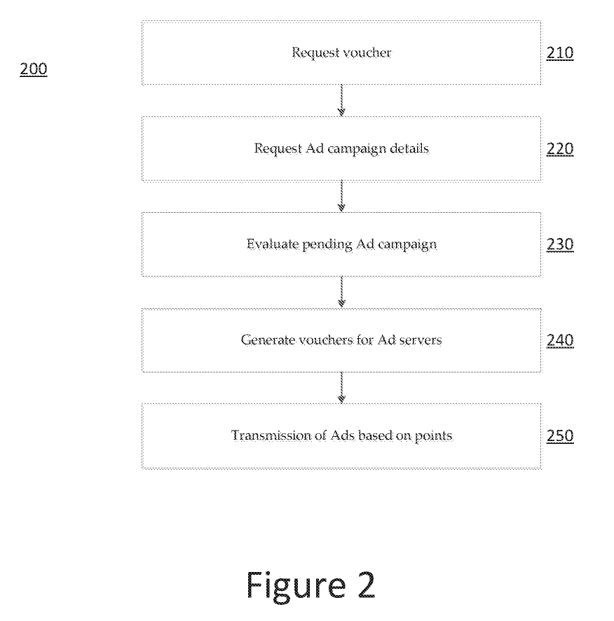

FIG. 2 illustrate a method 200 for managing advertisements using the voucher system of FIG. 1. As noted above, the advertisements provided by each ad server is controlled by the use of a voucher that dictates, for example, how many times a particular advertisement can be shown within a set period of time. Each transmission of the advertisement from the ad server to a client device may constitute one point. Once the voucher has been expended (i.e. value of the voucher is zero), the ad server may be prevented from sending out further advertisements until the next issued voucher. In some cases, the ad server may automatically request a new voucher and wait until it receives a new voucher indicating that transmission of advertisements to client devices can resume.

In step 210 an ad server may transmit a request for a voucher. The voucher would authorize and dictate how advertisements stored within the ad server would be distributed to client devices within the voucher system. Each voucher request would include a unique identifier associated with the ad server that can be used by the processor and other elements within the voucher system to associate the voucher request with the appropriate ad server.

The ad server may transmit the request for the voucher to the processor at pre-determined periods of time. If an advertisement campaign is active, the ad server may eventually receive a voucher responsive to the request from the processor. However, if no advertisement campaigns are available, a notification from the processor to the ad server may inform the ad server that no voucher may be available at this time. The ad server may then wait until the next period of time when another request can be transmitted.

In another embodiment, the ad server may also request vouchers automatically when points on a previously assigned voucher have been depleted. When a subsequent voucher will be issued may depend on the instructions stored in the wallet store. In some cases, a new voucher may not be assigned until the next period of time so as to control the distribution of advertisements over a span of the advertisement campaign. However, there may be situations where no such time constraint may be in place in which case, a new voucher may be issued immediately upon request.

In step 220, the processor request details regarding the advertisement campaign corresponding to the voucher request coming from the ad server. Since the processor may be managing many different advertisement campaigns run on the ad servers simultaneously, the processor may not immediately know the status or details about the advertisement campaign associated with the voucher request. Therefore, the processor would need to contact the voucher manager worker in order to retrieve information regarding the advertisement campaign associated with the voucher request. As described above, the voucher manager worker contains details for advertising campaigns. Furthermore, calculations regarding how many points should be distributed on each voucher to each ad server would also be performed here. In situations where there is no pending advertisement campaign associated with the voucher request from the ad server, the processor may provide notification of the same to the corresponding ad server coming from the voucher manager worker.

In step 230 details about the advertisement campaign are evaluated. For example, such details may include how many points are remaining and the remaining duration of the advertisement campaign. Furthermore, details may include instructions regarding a rate (e.g. how many points should be assigned per pre-determined time frame) of how the points should be issued per voucher. In some cases, if an advertisement campaign is almost finished, the point allotment on vouchers can be adjusted up or down in order to ensure that points can still be assigned via vouchers throughout the remaining time frame of the advertisement campaign and ensure that all points have been used up as well upon expiration of the advertisement campaign.

Furthermore, past details regarding how the vouchers were fulfilled from each assigned ad server associated with the advertisement campaign can also influence how vouchers are generated and assigned. As noted above, the speed at which points are depleted from a voucher and whether vouchers consistently still have points remaining after a period of time can be used to adjust point distributions on vouchers for each ad server. This calculation can be based on the information provided from each of the ad servers regarding if or when the points on the voucher has been depleted. For example, the ad servers can provide information regarding when all points have been used up with assigned vouchers in comparison to the expiration of the voucher. This may indicate that more points can be assigned to the ad server. In contrast, if there are still points remaining after the voucher expired, this may indicate that fewer points should be assigned to that ad server. By re-adjusting the allocation of points across the different ad servers based on a rate of fulfillment, this can at least ensure that the points will be regularly used up by the end of the voucher time period. Having left over (e.g. surplus) points may affect future calculations and prevent the voucher system from using up all the available points by the end of the advertisement campaign period.

In step 240 vouchers for each ad server is generated by the processor. Each voucher would include the unique identifier of the ad server for delivery to (and subsequent tracking of) point usage by the corresponding ad server. The vouchers would also include a point value that corresponds to the number of times advertisements may be transmitted to client devices. Lastly, the voucher may include details regarding what type of advertisements should be provided to which client devices. In some embodiments where advertisement campaigns are targeted to specific users, the ad servers may include instructions regarding what features should be detected regarding client devices before an advertisement is transmitted to the client device.

In step 250, the ad servers transmit advertisements to corresponding client devices. As an advertisement is transmitted to a client device, a value associated with the voucher is decremented. In situations where the ad server can transmit batches of advertisements (i.e. more than one advertisement) to the client device, the voucher may be decremented a number equal to the number of advertisements within the batch.

The ad server may be triggered to provide advertisements to client devices in many different ways. For example, the client device may establish a connection with the ad server and request an advertisement to be shown. Such connection with one of the many possible ad servers may be random. In some situations, this connection may be established based on some shared feature found on the client device that is associated with the ad server. For example, if the client device includes information regarding a user's interest or history, a connection can be formed between the client device and one or more ad servers that contain advertisements associated with the user's interest or history. In a further embodiment, connections between client devices and ad servers can also be established based on a load balancing process in order to ensure that data transmission between client devices and ad servers are even (i.e. one or two ad servers are not assigned all the workload for the entire voucher system).

Regardless of how the ad servers are selected based on the different methods described above, the possible pool of ad servers may only include those ad servers that have value (e.g. points) left on their assigned voucher. Once an ad server has depleted all value from their voucher, they may be removed from future assignments to client devices until a new voucher has been assigned.

Each time the client device connects to the voucher system, a connection between the client device and an ad server can be established for the transmission of an advertisement. Even if the same client device connects to the same voucher system multiple times within a period of time, the client device may be assigned different or the same ad server based on conditions established by the advertisement campaign.

FIG. 3 illustrates the voucher system of FIG. 1 within an overall points system 300. The point system 300 represents a scalable implementation of the voucher system of FIG. 1 whereby multiple ad servers can be managed by the processor to dictate how advertisements can be provided to client devices during an advertisement campaign. Specifically advertisements from other parties can be uploaded and advertisement campaigns can be created and managed with the voucher system described above in FIG. 1. The point system 300 also includes elements associated with advertisement management applications that could also be compatible with the voucher system of FIG. 1.

With respect to the figure, the voucher system (illustrated in FIG. 1) is incorporated into the point system 300. These elements 305-330 operate in a similar manner. Differences from the voucher system of FIG. 1 and the point system implementation in FIG. 3 includes the inclusion of multiple servers 310A, 310B that include advertisements that can be provided to the client devices 305 and the processor 315 (e.g. Kafka Broker) that includes more processes for the additional elements present in the point system 300.

With respect to the advertisement servers 310A, 310B, there may be a plurality of different servers that can be used to store advertisements that can be provided to the client device 305. The advertisement servers 310A, 310B (as described in FIG. 1) would connect with various client devices 305 in order to push particular advertisements for user views. Which advertisement is provided to the client device 305 from the advertisement servers 310A, 310B can be controlled by instructions associated with the advertisement campaign. Furthermore, the point system 300 may dictate which advertisement server 310A, 310B should connect with the client device 305 based on, for example, on the subject matter of the advertisements within a particular advertisement server and the user's interest. Alternatively, a load balancing feature can also be used to assign advertisement servers so that the transactions do not solely revolve around a few ad servers from the plurality of ad servers.

With respect to the processor 315 of FIG. 3, additional processes are included that facilitates communication between the processor 315 with the additional components of the point system 300. The wallet update topic processes information associated with the voucher points that have been used by ad servers and provides information, for example, to Camus 350 that can be used to update details about the campaign (e.g. points remaining). The campaign update processes information from the campaign API 340 in order to update status of the campaign. For example, request for extension of time frame of the advertisement campaign and/or additional points to be added can be received by the campaign application program interface (API). The campaign update process is then used to forward the information so that the corresponding advertisement campaign is updated accordingly. The reporting process processes the advertisement campaign transactions to that it can be used by the reporting worker 365 to publish information in response to queries about the advertisement campaign.

The point system 300, as illustrated, includes a plurality of additional elements that could work with the voucher system of FIG. 1. For example, X-Promo Admin 335 and Campaign APIs 340 could be used to facilitate additional advertisement campaigns within the point system 300. The X-promo admin 335 may be associated with an advertisement service that would like to incorporate their advertisements into the point system 300. The X-promo admin 335 can also correspond to an entity (e.g. company, individual) as well.

The X-promo admin 335 provides information to the campaign API 340 that includes uploaded advertisements and details about advertisement campaign to be carried out by the point system 300. The advertisement campaign information provided by the X-promo admin 335 via the campaign API 340 can include details such as which advertisement(s) should be run during the campaign, the duration of the campaign, how many points the campaign will be allocated, and any specifics regarding which client devices the advertisements should be targeted towards. The campaign API 340 would facilitate the upload of the advertisements into corresponding ad servers 310A, 310B as well as associating the details regarding how the advertisement campaign should be run.

The campaign API 340 can also be used to request modifications to existing advertisement campaigns currently run on the point system 300. Modifications may include lengthening or shortening the duration of the advertisement campaign, adding additional points to the advertisement campaign, or modifying details identifying client devices that the ad servers associated with the advertisement campaign should focus on.

Furthermore, the point system 300 can also include additional elements that facilitate the management of the voucher and points associated with the various advertisement campaigns run on the point system. For example, a plurality of workers

With reference to the figure, Camus 345 refers to a pipeline that can be used to load point transactions and any updates about advertisement campaigns from the processor 315 into Hadoop 350. Hadoop 350 represents a database for any numbers (e.g. voucher values/points) associated with the advertisement campaigns run on the point system 300. In this way, Hadoop 350 can be referenced in order to monitor views for advertisements associated with the point system 300. The information in Hadoop can be used to update the wallet store at regular intervals.

The points transaction worker 355 operates as a counter that tracks point values for vouchers and pending advertisement campaigns. In particular, the points transaction worker 355 is used to track point values regarding when advertisements are shown. For example, advertisements may be played at pre-determined intervals or intermissions associated with content (e.g. video, game). The points transaction worker can identify the source (e.g. video, game) associated with when the advertisement is shown.

The campaign manager worker 360 processes the information provided via the campaign API 340. In particular, the campaign manager worker 360 provides campaign update notices to the processor 315 that can be used to update advertisement campaigns. For example, a campaign process can be used by the processor 315 to allocate points to existing advertisement campaigns. Such an embodiment would be useful if the advertisement campaign is extended or would be aimed at providing more views to client devices 305 within the time frame of the advertisement campaign.

The reporting worker 365 processes information from the processor 315 (via the reporting process) that is used for reporting advertisement campaign transactions that have occurred thus far. The reporting worker 365 may create a time series view of advertisement campaign transactions regarding the vouchers and points associated with the wallet store. These transactions can then be stored in a database that is later relied on by the reporting solution 375. The reporting solution 375 provides the information about the advertisement campaign to the corresponding entities.

In an example implementation of the reporting solution 375, a company may wish to advertise their product with a number of different content. For example, the advertisement may be played at pre-determined periods of time or during intervals associated with content A (e.g. movie), content B (e.g. game), and content C (e.g. television show). The reporting solution 375 can compile the number of times the company's advertisement was shown to different users with respect to content A, B, and/or C (e.g. the advertisement was shown 500 times with respect to content A, 250 times with respect to content B, and 400 times with respect to content C during the same period of time.) This information may be useful to determine success of the advertisement campaign and for future advertisement campaigns. For example, the company can use the information from the reporting solution 375 to identify which content the advertisement was shown on the most along with frequency of user interaction with the shown advertisement. The company may modify a current advertisement campaign to focus more on the sources where the content was most shown and interacted with by the viewer more so while reducing emphasis on the sources where advertisements were shown and interacted less by viewers.

With the voucher system implementation within the point system 300 of FIG. 3, a benefit is present with the scalability of the voucher system aspect. The processor 315 may be capable of managing advertisement campaigns for a set number of ad servers 310A, 310B. This set up may further be capable of distributing advertisements to a set number of client devices within a set time frame. Thus an issue arises if the number of client devices that need to be services increases.

With each grouping of processor and ad servers acting as a separate advertisement cluster, additional advertisement clusters (of processors and ad servers) can be added in parallel to existing advertisement clusters in order to further provide additional sources of advertisement that can be distributed to more client devices. As referred to herein, advertisement clusters correspond to groupings of ad servers and a respective processor used to manage the voucher system functionality. Since the majority of the workload is performed via the processor (e.g. processing of advertisement campaign transactions, generation of vouchers) there is minimal affect with the inclusion of additional advertisement clusters to the other components of the point system. The other components of the point system 300 (e.g. wallet store, voucher manager worker) could be shared for the purposes of updating and tracking advertisement campaign progress. Any issues surrounding the shared components of point system 300 (e.g. multiple clusters wishing to access the wallet store simultaneously) may be solvable via scheduling the accesses performed by different advertisement clusters.

Another benefit with the point system would allow for managing cross promotions by multiple different entities. There may be some situations where two or more companies agree to show another company's advertisement in connection with their product respective products. The point system would allow the companies to ensure that the advertisements subject to the cross promotion are being shown as agreed. For example, company A may agree to show company B's advertisement within content associated with company A and vice versa. Using, for example, the points transaction worker, the overall point system could be used to track how many times a particular advertisement is shown at a particular source. This allows company A to know that company B is showing company A's advertisement a pre-determined number of times associated with the content associated with company B and vice versa.

FIG. 4 illustrates a block diagram of an example device 400. The exemplary device 400 (e.g., desktop, laptop, tablet, mobile device, console gaming system) is a device that can be used to carry out the features of the present invention. As shown, in the figure, the device 400 includes one or more network interfaces 410 (e.g., transceivers, antennae, etc.), at least one processor 420, and a memory 440 interconnected by a system bus 450.

Network interface(s) 410 contain the mechanical, electrical, and signaling circuitry for communicating data over links coupled to one or more networks. Network interfaces 410 are configured to transmit and/or receive data using a variety of different communication protocols, as will be understood by those skilled in the art. For example, the network interfaces 410 can be used to communicate with the ad server in order to 1) provide generated vouchers, and 2) receive information regarding transactions associated with the vouchers (e.g. value on the voucher that's remaining, the time it took for the value on the voucher to be depleted).

Memory 440 comprises a plurality of storage locations that are addressable by processor 420 for storing software programs and data structures associated with the embodiments described herein. For example, memory 440 can include a tangible (non-transitory) computer-readable medium, as is appreciated by those skilled in the art. Example programs may include those that facilitate in the creation of the generated vouchers that are provided to the ad servers. Other programs may facilitate the communication of information between the ad server and the wallet store.

Processor 420 may comprise necessary components, elements, or logic adapted to execute the software programs and manipulate data structures 445, which are stored in memory 440. An operating system 442, whereby portions of which are typically resident in memory 440 and is executed by processor 420, can be used to functionally organize the device 400 by invoking operations in support of software processes and/or services executing on the device 400. These software processes and/or services may comprise an illustrative “media integration” process/service 444 that allows for the communication of the information coming from the ad server to be provided to the voucher system components (e.g. wallet store, voucher manager) and vice verse. Note that while process/service 444 is shown in centralized memory 440, the process/service 444 may be configured to operate in a distributed communication network.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 420 can include one or more programmable processors, e.g., microprocessors or microcontrollers, or fixed-logic processors. In the case of a programmable processor, any associated memory, e.g., memory 440, may be any type of tangible processor readable memory, e.g., random access, read-only, etc., that is encoded with or stores instructions that can implement program modules, e.g., a module having spectator channel process 444 encoded thereon. Processor 420 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed:

1. A method for managing advertisements, the method comprising:
providing a plurality of advertisements associated with a plurality of ad servers;
receiving a request for transmitting advertisements from the plurality of ad servers;
identifying advertisement campaign details associated with the received requests, the advertisement campaign details including a total number of points allocated for a pre-determined duration that an advertisement campaign will be active;
generating a voucher for the ad server associated with the advertisement campaign, the voucher including an assigned point value and an expiration time;
transmitting the voucher to the ad server, wherein the voucher dictates conditions regarding transmission of advertisements from the ad server to a client device;
receiving information from the plurality of ad servers regarding advertisement transactions between the ad server and the client device associated with the advertisement campaign; and
generating subsequent vouchers for the plurality of ad servers until the total number of points of the advertisement campaign have been depleted or the pre-determined duration of the advertisement campaign has expired.

2. The method of claim 1, wherein the advertisement campaign details includes a feature for rate limiting transmission of advertisements from the ad servers, the rate limiting corresponding to an allocation of a subset of the total number of points for a subset of the pre-determined duration of the advertisement campaign.

3. The method of claim 1, wherein the assigned point value corresponds to a number of times one ad server is allowed to transmit advertisements associated with the advertisement campaign to the client device.

4. The method of claim 3, wherein the assigned point value is decremented based on a number of advertisements transmitted from one ad server to the client device.

5. The method of claim 1, wherein the received information includes user activity associated with the advertisement at the client device.

6. The method of claim 5, wherein the user activity includes impressions, clicks, and hovers.

7. The method of claim 1, wherein the received information includes an indication whether there is any points left on the voucher after the expiration of the voucher.

8. The method of claim 1, wherein the received information includes an indication when all the points on the voucher have been depleted prior to the expiration of the voucher.

9. The method of claim 1, wherein the generating subsequent vouchers includes:
evaluating the received information from a first ad server of the plurality of ad servers, the received information corresponding to the first ad server point usage;
calculating a new point value for the first ad server, the new point value corresponding to a different allocation of points to vouchers based on the evaluation that still satisfies the advertisement campaign details; and
generating a voucher for the first ad server utilizing the new point value, the new point value affecting a distribution of points to other ad servers

10. The method of claim 9, wherein the new point value for the first ad server increases a number of advertisements that can be transmitted from the first ad server to the client device, wherein the increase collectively decreases a number of advertisements that can be transmitted from other ad servers to the client device.

11. The method of claim 9, wherein the new point value for the first ad server decreases a number of advertisements that can be transmitted from the first ad server to the client device, wherein the decrease collectively increases a number of advertisements that can be transmitted from other ad servers to the client device.

12. The method of claim 1, wherein the advertisement campaign details includes targeting specific client devices that are compatible with the advertisement.

13. The method of claim 1 further comprising establishing connections between the client device and one of the ad servers from the plurality of ad servers, the connection being active until the connected ad server transmits the advertisement to the client device.

14. The method of claim 13, wherein the established connection identifies the one ad server randomly.

15. The method of claim 13, wherein the established connection identifies the one ad server based on load balancing criteria.

16. The method of claim 13, wherein the established connection identifies the one ad server based on compatible subject matter shared between the one ad server and the client device.

17. The method of claim 16, wherein the compatible subject matter includes user preference, interest, viewing history, and purchase history.

18. A system for managing advertisements, the system comprising:
a campaign server, the campaign server including campaign details that dictate transmission of advertisements to a plurality of client devices;
a plurality of client devices that receive and display for a user to view advertisements from the ad servers; and
an advertisement cluster, the advertisement cluster includes:
a plurality of ad servers that store a plurality of advertisements, and
a processor that manages advertisements for the plurality of ad servers, the processor executing instructions stored in memory to:
receive a request for transmitting advertisements from the plurality of ad servers,
identify advertisement campaign details associated with the received request, the advertisement campaign details including a total number of points allocated for a pre-determined duration that an advertisement campaign will be active,
generate a voucher for the ad server associated with the advertisement campaign, the voucher including an assigned point value and an expiration time;
transmit the voucher to the ad server, wherein the voucher dictates conditions regarding transmission of advertisements from the ad server to the plurality of client devices;
receive information from the plurality of ad servers regarding advertisement transactions between the ad server and the plurality of client device associated with the advertisement campaign; and
generate subsequent vouchers for the plurality of ad servers until the total number of points of the advertisement campaign have been depleted or the pre-determined duration of the advertisement campaign has expired

19. The system of claim 18, wherein the system is scalable by incorporating additional advertisement clusters.

20. A computer readable non-transitory storage medium having embodied therein a program, the program being executable by a processor to perform a method for managing advertisements, the method comprising:
providing a plurality of advertisements associated with a plurality of ad servers;
receiving a request for transmitting advertisements from the plurality of ad servers;
identifying advertisement campaign details associated with the received requests, the advertisement campaign details including a total number of points allocated for a pre-determined duration that an advertisement campaign will be active;
generating a voucher for the ad server associated with the advertisement campaign, the voucher including an assigned point value and an expiration time;
transmitting the voucher to the ad server, wherein the voucher dictates conditions regarding transmission of advertisements from the ad server to a client device;
receiving information from the plurality of ad servers regarding advertisement transactions between the ad server and the client device associated with the advertisement campaign; and
generating subsequent vouchers for the plurality of ad servers until the total number of points of the advertisement campaign have been depleted or the pre-determined duration of the advertisement campaign has expired
